(19) United States
(12) Patent Application Publication
(10) Pub. No.: US 2003/0123076 A1
(43) Pub. Date: Jul. 3, 2003

(54) Method of printing local area of image and a local set therefor

(75) Inventor: Ji-sub Park, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Suwon-city (KR)

(21) Appl. No.: 10/166,710

(22) Filed: Jun. 12, 2002

(30) Foreign Application Priority Data
Dec. 28, 2001 (KR) 2001-86885

(51) Int. Cl. B41B 1/00; G06F 15/00

(52) U.S. Cl. 358/1.13

(57) ABSTRACT

A method of printing only a local area of an image using a remote control panel application program unit and a local set therefor. The method includes printing the local area of the image by uploading image data regarding the image to a personal computer PC, displaying the image on a screen of the PC, designating a local area of the displayed image by a user, and directly printing local image data of the local area by the local set without uploading or downloading the local image data to the PC or the local set. The method includes converting command data regarding the local area, which was designated by the user and transmitted from the personal computer, into control data that can be used by the image sensor interface by the controller, generating image local data of the local area by scanning only the local area of the image by the image sensor based on the converted control data of the local area, converting the generated local image data of the local area into print data by the controller via the image sensor interface so as to print the local image corresponding to the local image data, and printing the converted print data by a printer.

### CROSS-REFERENCE TO RELATED APPLICATIONS

This application claims the benefit of Korean Application No. 2001-86885, filed Dec. 28, 2001, in the Korean Industrial Property Office, the disclosure of which is incorporated herein by reference.

### BACKGROUND OF THE INVENTION

1. Field of the Invention

The present invention relates to a method of printing only a local area of an image using a remote control panel (RCP) application program unit, and a local set therefor, and more particularly, to a method of printing only a desired local area of an image by uploading data regarding the image by a personal computer (PC), displaying the image on a screen of the PC, designating a local area of the displayed image by a user, and directly printing image data of the local area without uploading or downloading the image data of the local area to the PC or the local set, and a local set therefor.

2. Description of the Related Art

In general, a local set is referred to as a machine including two or more products having different functions. For instance, the local set may be a combination of a printer and a scanner device. FIG. 1 is a block diagram of a conventional local set 90 and personal computer (PC) 100. Referring to FIG. 1, if a user prints a local area of an image using a conventional local set 90, the user must first entirely scan the image to display on a screen of the personal computer 100, scan the local area of the image, which the user wishes to print, to display the scanned local area on the screen, and select a command of printing the displayed local area.

As shown in FIG. 1, the local set 90 of includes a controller 10 controlling all of components constituting the local set 90 according to a set of programs, a memory 20 storing the programs operated or controlled by the controller 10 and data obtained by performing the programs by the controller 10, such as image data obtained by an image sensor 80, a printer 30 printing the data contained in the memory 20, or data transmitted from a printer driver 120 of the 100, a PC interface 40 functioning as an interface when image data of the local area obtained by the image sensor 80 is transmitted to a PC scan driver 110 or converting the image data of the local area into printing data that can be controlled by the PC scan driver 110 and then transmitting the converted printing data to the printer 30, an operating panel 60 having a plurality of keys to generate key data to the controller 10 when one of the keys is pressed, a liquid crystal display (LCD) 70 displaying an operation state of the local set 90 in response to display data generated by the controller 10, and an image sensor interface 50 functioning as an interface when data is transmitted between the image sensor 80 and the controller 10.

FIG. 2 is a flow chart explaining a conventional method of printing only a local area selected by a user in the local set 90 and the PC 100. Referring to FIG. 2, first, the user scans an overall image of an original copy 200, and uploads the image data of the overall image to the PC 100 from the local set 90. Then, the overall image of the original copy is displayed on a screen of the PC 100 using a remote control panel (RCP) application program unit 130 in response to the uploaded image data, and then, a desired local area of the overall image is designated by the user. Local image data of the local area is processed and printed by the local set 90 after being uploaded to the PC 100.

The conventional method of printing the desired local area of the overall image with the local set 90, using the RCP application program 130, is as follows (refer to FIGS. 1 and 2). The user places the original copy 200 on the image sensor 80 and then inputs a command to scan the original copy 200 using a mouse or keyboard connected to the PC 100 in operation S20. The PC scan driver 110 receives the command and transmits a corresponding control command to the controller 10 of the local set 90 via the PC interface 40. The controller 10 transmits the control command to the image sensor interface 50, and then, the image sensor 80 obtains the overall image of the original copy 200 to generate overall image data representing the overall image of the original copy 200 by entirely scanning the original copy 200 in operation S21. The image sensor interface 50 performs a first uploading operation of uploading the overall image data of the original copy 200 to the PC scan driver 110 via the PC interface 40 in response to the control command from the controller 10, and as a result, the overall image is displayed on the screen of the PC 100 through the RCP application program unit 130 in operation S22. The user designates the desired local area of the overall image of the original copy 200, which is displayed on the screen, to be printed in operation S23 and then generates a scanning command to scan the desired local area of the original copy 200 in operation S24. The PC scan driver 110 translates the scanning command, and transmits a corresponding control command to the controller 10 of the local set 90 via the PC interface 40.

The controller 10 transmits the second control command to the image sensor interface 50, and then, the image sensor 80 scans the local area of the original copy 200 and obtains the local image data thereof according to the second control command of the controller 10 and the scanning command generated by the user in operation S25. The image sensor interface 50 transmits the local image data of the local area of the original copy 200 to the PC computer interface 40 in response to the second control command by the controller 10. The local image data of the local area of the original copy 200 is secondly uploaded to the PC scan driver 110 via the PC interface 40, and then is displayed on the screen of the PC 100 through the RCP application program unit 130 in operation S26.

The user selects a print command of printing the local area in the PC 100 by using the mouse or keyboard in operation S27. If the print command is selected by the user, the printer driver 120 installed in the PC 100 converts the local image data of the local area into print data in operation S28. The controller 10 of the local set 90 downloads the converted local image data to the printer 30 from the printer driver 120 via the PC interface 40 in operation S29 and prints the local area, thereby obtaining a completed printed material of the local area 210.

The above conventional method of printing the local area of the overall image is, however, disadvantageous in that a lot of time is consumed in uploading the overall and local image data of the original copy 200 to the PC 100 twice. Further, there is a discrepancy between the printed local image and the uploaded or downloaded the local image, i.e., there is a higher probability that the original image of the local area of the original copy 200 is changed due to a color look-up table conversion caused during the uploading and downloading.

Similarly, Japanese Laid-Open Patent No. Hei 9-037063 discloses a method of copying a local area by setting a printing position of the local area and editing the local area on a preview screen, and then enlarging, reducing or rotating the local area. Japanese Laid-Open Patent No. Hei 11-331516 suggests a scanner capable of reducing time consumed in scanning an image by setting a size of paper to be scanned, and a start/end position in advance, and scanning the paper in response to set items. Japanese Laid-Open No. Hei 10-126606 is directed to an image processor capable of designating a predetermined region of an image screen and editing/printing a designated image of the predetermined region. Japanese Laid-Open No. Hei 11-088612 shows a device setting an image region to be scanned in advance, and editing and printing an image input corresponding to the image region.

However, none of the above publications discloses a method of printing only a local area of an image designated by a user.

### SUMMARY OF THE INVENTION

To solve the above and other problems, it is an object of the present invention to provide a method of printing only a local area of an image while minimizing time consumed in uploading/downloading image data of the local area, and minimizing a discrepancy between an image printed by a local set and an image uploaded and downloaded to a personal computer, and a local set performing the method.

Additional objects and advantages of the invention will be set forth in part in the description which follows and, in part, will be obvious from the description, or may be learned by practice of the invention.

To achieve the above and other objects, there is provided a method of printing a desired local area of an image by displaying an overall image of an original copy on a screen of a personal computer through an RCP application program unit, and printing the local area designated by a user, wherein the overall image is uploaded to a personal computer scan driver via an image sensor, an image sensor interface, a controller and a personal computer interface, and then is displayed through the RCP program program unit. The method includes converting command data regarding the local area, which was designated by the user and transmitted from the personal computer, into control data that can be used by the image sensor interface and the controller, generating local image data of the local area by scanning only the local area of the image by the image sensor based on the converted control data, converting the generated local image data of the local area into print data by the controller via the image sensor interface so as to print the image data, and printing the converted print data.

According to an aspect of the present invention, the local image data of the local area includes image size and coordinate information of the local area with regard to the overall image of the original copy.

According to another aspect of the the present invention, there is provided a local set printing the desired local area of the image by displaying the overall image of the original copy on the screen of the personal computer through the RCP application program unit, designating the local area by the user, and printing the designated local area, wherein the overall image is uploaded to the personal computer scan driver via the image sensor, the image sensor interface, the controller and the personal computer interface, and then displayed through the RCP application program unit. The local set includes the controller converting the command data of the local area, which is designated by the user and transmitted from the personal computer, into the control data that can be used by the image sensor interface. The controller converts the local image data of the local area, which is generated by scanning only the local area by the image sensor, into the print data to be printed by the printer based on the converted control data and transmits the converted print data.

The control data of the local area includes the image size and coordinate information of the local area with respect to the overall image of the original copy.

The local set includes a memory storing a program operated or generated by the controller, data generated by performing the program by the controller, and image data obtained by the image sensor.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a general local area set and a personal computer;

FIG. 2 is a flow chart explaining a conventional method of printing only a local area of an image in a local set; and

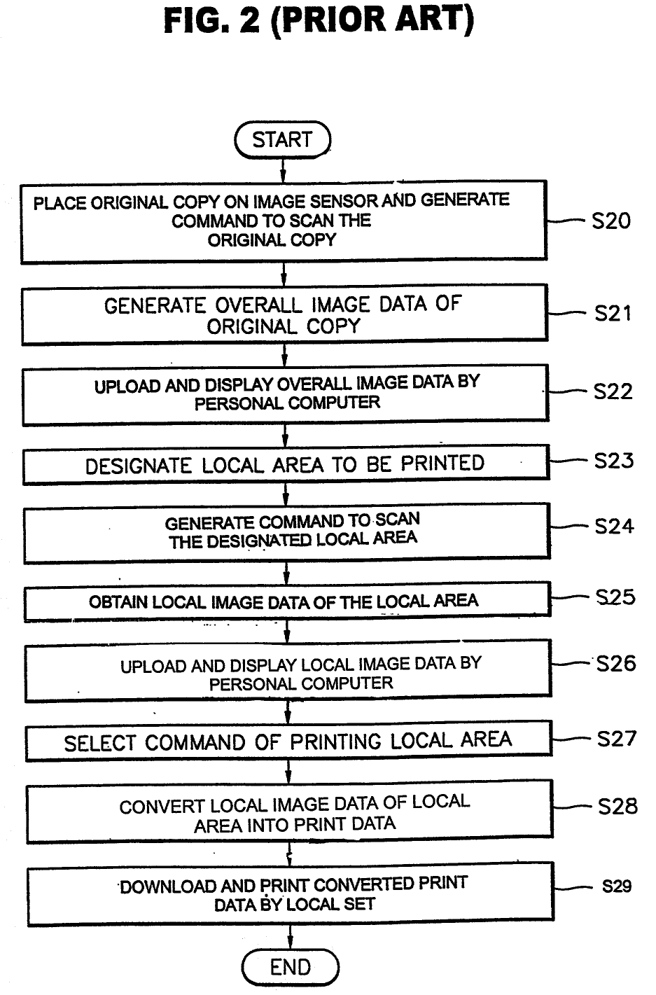

FIG. 3 is a flow chart explaining a method of printing only a local area of an image in a local set according to the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention be referring to the figures.

Hereinafter, a method of printing only a local area of an image designated by a user through a remote control panel (RCP) application program unit, and the local set therefor will be described with reference to the accompanying drawings.

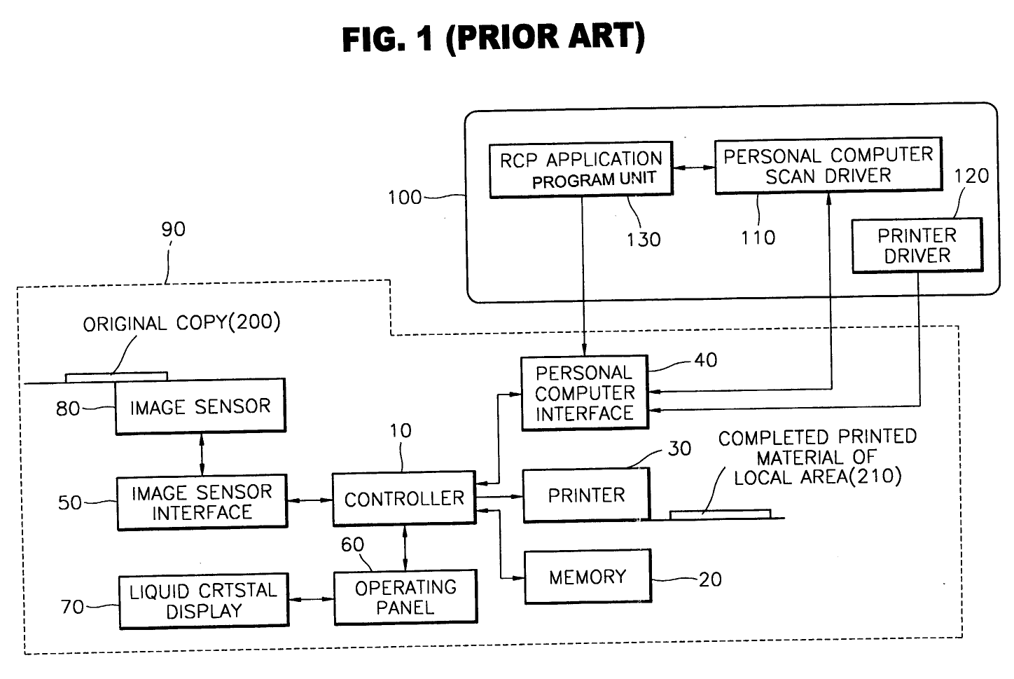

The local set according to an embodiment of the present invention may use the same block diagram as that of the conventional local set illustrated in FIG. 1. However, a controller 10 and all other components communicating with the controller 10 according to the embodiment of the present invention are different from the conventional local set and personal computer. Therefore, the same components will be described with the same reference numerals and explanations thereof will be omitted.

In detail, the controller 10 converts command data of a local area of an image, which was transmitted from a personal computer (PC) and designated by a user, into control data that can be used by an image sensor interface 50, converts local image data generated by scanning only the local area by an image sensor 80 based on the converted control data, into print data that can be printed by a printer 30, and transmits the converted print data to the printer 30. Accordingly, operations of the controller 10 according to an embodiment of the present invention are different from that of the conventional controller.

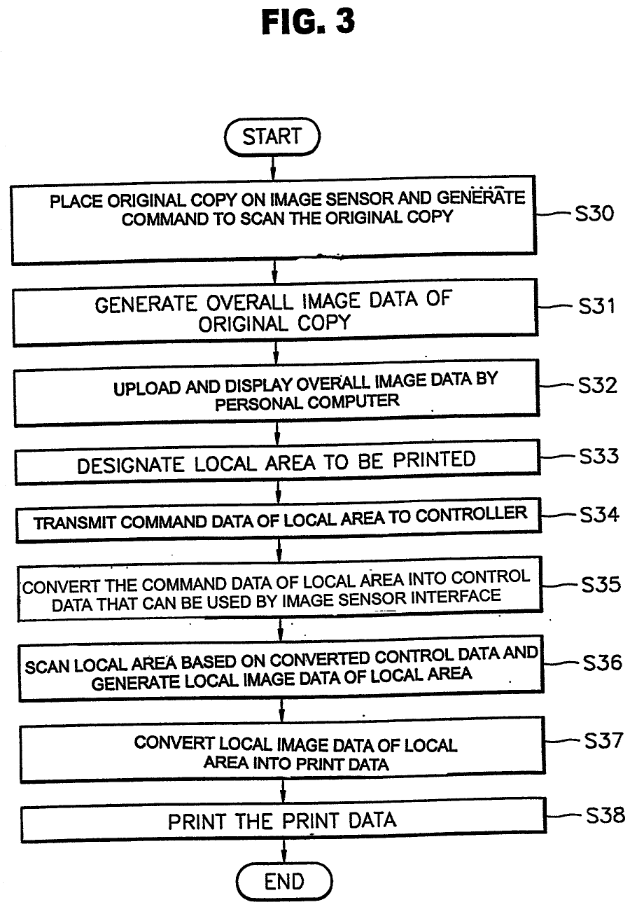

FIG. 3 is a flow chart explaining a method of printing the local area of the image designated through the RCP application program unit 130. Referring to FIG. 3, in order to print the local area of the image, the user scans the overall image of the original copy 200, uploads the scanned overall image from the local set 90 to the personal computer (PC) 100, and displays the uploaded overall image of the original copy on a screen of the PC 100 through the RCP application program unit 130. Then, the user designates a desired local area of the overall image of the original copy 200. Next, through the RCP application program unit 130, command data of the local area is transmitted to the controller 10, and the controller 10 processes print data to be printed by the printer 30 and transmits the print data to the printer 30. As a result, the local area of the original copy 200 is printed by the printer 30.

The method of printing the local area designated through the RCP application program unit 130 via the local set 90, according to the embodiment of the present invention, is as follows:

The user places an original copy 200 on the image sensor 80 and then generates a scanning command scanning the original copy 200 using a mouse or keyboard connected to the PC 100 in operation S30. The PC scan driver 110 receives the scanning command and transmits a control command to the controller 10 of the local area 90 via the PC interface 40. The controller 10 transmits the control command to the image sensor interface 50, and then, the image sensor 80 obtains the overall image of the original copy 200 by scanning the original copy in operation S31. The image sensor interface 50 performs a first uploading operation of uploading the overall image of the original copy 200 to the PC scan driver 110 via the PC interface 40 in response to the control command from the controller, and as a result, the overall image is displayed on the screen of the PC 100 through the RCP application program unit 130 in operation S32.

The user designates the desired local image to be printed from the overall image of the original copy 200 displayed on the screen in operation S33. Through the RCP application program unit 130, command data regarding the local area designated, e.g., the size and coordinate information of the local area, with respect to the overall image of the original copy 200, is transmitted to the controller 10 via the PC interface 40 in operation S34. The controller 10 converts the command data into control data that can be used by the image sensor interface 50 in operation S35. The image sensor 80 scans the local area based on the converted control data, and generates the local image data of the local area in operation S36. The controller 10 converts the local image data into print data in operation S37 and the print data is printed by the printer 30, thereby obtaining a complete printed material of the local area in operation S38.

The local image data is generated after the local area of the original copy 200 is automatically scanned in response to the size and coordinate information of the control data converted from the command data. The local image data is also automatically converted into the print data representing the local image of the local area having a size being different from that of the local area of the original copy 200 in response to the size and coordinate information of the control data.

While this invention has been particularly shown and described with reference to a preferred embodiment thereof, it will be understood by those skilled in the art that various changes in form and details may be made therein without departing from the spirit and scope of the invention as defined by the appended claims.

As described above, with a method of printing only a local area of an image and a local set, according to the embodiment of the present invention, the local area can be printed by obtaining command data of the local area through the RCP application program unit of a host computer and processing the control data obtained by a controller and local image data directly to be printed without uploading the local image data of the local area to the host computer twice. Therefore, it is possible to reduce time consumed in printing the local area and prevent the deformation of the image caused by a color look-up table conversion used during uploading and downloading the image data, thereby obtaining a good printing quality of the image.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of printing a desired local area of an image in a printer by displaying the overall image of an original copy on a screen of a personal computer through an RCP application program unit and printing the local area, wherein the overall image is uploaded to the personal computer scan driver from a local set having an image sensor, an image sensor interface, a controller and a personal computer interface and then is displayed through the RCP application program unit, the method comprising:
converting command data regarding the local area, which is transmitted from the personal computer, into control data that is used by the image sensor interface by the controller;
generating local image data of the local area by scanning only the local area of the image by the image sensor based on the converted control data of the local area;
converting the generated local image data of the local area into print data by the controller via the image sensor interface in response to the control data; and
printing the converted print data.

2. The method of claim 1, wherein the control data of the local area comprises size and coordinate information of the local area with regard to the overall image of the original copy.

3. A local set for printing only a desired local area of an image in a system uploading an overall image of an original copy to a personal computer, displaying the overall image of the original copy on a screen of the personal computer through an RCP application program unit, designating the local area, and printing the designated local area, the local set comprising:
a controller converting command data of the local area, which is transmitted from the personal computer, into control data that is used by the image sensor interface, and converting local image data of the local area, which is generated by scanning only the local area by the image sensor in response to the control data, into print data to be printed in response to the control data.

4. The local set of claim 3, wherein the control data of the local area comprises image size and coordinate information of the local image of the local area with respect to the overall image of the original copy.

5. The local set of claim 3, further comprising a memory storing a program operated or generated by the controller, data generated by performing the program by the controller, and overall and local image data obtained by the image sensor.

6. The local set of claim 3, wherein the controller does not upload the generated local image data to the personal computer.

7. The local set of claim 3, wherein the image sensor interface automatically controls the image sensor to scan the local area of the original copy and generates the local image data in response to the control data and automatically converts the generated local image data to the print data in response to the control data.

8. The local set of claim 3, wherein the controller determines a size of a print image corresponding to the print data in response to the control data.

9. The local set of claim 3, further comprising a printer printing the print data representing a printing image of the local area in response to the control data.

10. A method in a local set scanning an original copy, generating an overall image data corresponding to an overall image of the scanned original copy, and uploading the overall image data to an external computer, the method comprising:
receiving command data relating to a local image of a local area contained in the overall image from the external computer;
scanning the original copy and generating local image data corresponding to the local image of the local area from the scanned original copy in response to the command data; and
converting the generated local image data to print data to print a print image corresponding to the print data in response to the command data.

11. The method of claim 10, wherein the local set comprises an image sensor and a sensor interface, and the method comprises converting the command data to control data to be used in the sensor interface to control the image sensor to scan the local image of the original copy and generate the local image data from the scanned local image.

12. The method of claim 11, wherein the local set comprises a controller, and the method comprises controlling the controller and the sensor interface to convert the generated local image data to the print data in response to the control data.

13. The method of claim 10, wherein the generated local image data is not uploaded to the external computer.

14. The method of claim 10, wherein the command data comprises coordinate information of the local area with respect to the overall image, and the scanning of the original copy comprises scanning the local area corresponding to the coordinate information.

15. The method of claim 10, wherein the command data comprises size information of the local area to be printed, and the converting of the generated local image data comprises converting the generated local image data to the print data corresponding to the size information.

16. The method of claim 10, wherein the command data comprises size and coordinate information, and the local area is scanned in accordance with the coordinate information of the command data, and the generated local image data is converted to the print data representing a print image having a size corresponding to the size information of the command data.

17. The method of claim 10, wherein the local set comprises a printer, and the method comprises controlling the printer to print a print image corresponding to the command data in response to the command data.

18. The method of claim 10, wherein the local set comprises a memory, and the method comprises storing the generated local image data, the print data, and the command data in the memory.

19. The method of claim 10, wherein the local area has a first size, and the print image has a second size different from the first size in accordance with the command data.

20. The method of claim 10, wherein the generated local image data is automatically converted in response to the command data.

21. The method of claim 10, wherein the local image of the local area is automatically scanned in response to the command data.
